(19) United States
(12) Patent Application Publication
(10) Pub. No.: US 2009/0288072 A1
(43) Pub. Date: Nov. 19, 2009

(54) Automatic Tests of Product Documentation

(75) Inventor: Jakub Kania, Bielsko-Biala (PL)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/120,804

(22) Filed: May 15, 2008

(51) Int. Cl. G06F 9/44

(52) U.S. Cl. 717/131

(57) ABSTRACT

A computer implemented method of software product documentation review involves importing a description of a structure of the product documentation for use in determining locations in the product documentation from which to extract code and/or command portions of the product documentation for testing and providing pre-defined test case stub files for the product documentation into which are inserted extracted portions of the product documentation for testing. The test case stub files are run with the code and/or command portions inserted to determine whether or not they are runnable which is indicative of whether or not an error is present in the documentation.

### FIELD OF THE INVENTION

This invention relates to a method of delegating and automating at least part of documentation review to software.

### DESCRIPTION OF BACKGROUND

After a software product has been on the market for several years, when the current documentation is reviewed, it is often discovered that the documentation contains errors when compared to the original software. Documentation review is a manual process that relies on the attention and competencies of the reviewers. There are currently a few tools that help the reviewers, but such tools are nothing more than collaboration software that allow simultaneous review of an electronic document. In other words, each reviewer can simultaneously review and add their respective comments and see the other reviewers' comments and eventually discuss those comments. There is nothing available that actually frees the reviewer to manually check the code samples, command line options, and compatibility/support tables.

### SUMMARY OF THE INVENTION

The shortcomings of the prior art are overcome and additional advantages are provided through the provision of a method of delegating and automating at least part of documentation review of software. Embodiments of the present invention propose a tool that automatically identifies errors in software documentation when compared to the original software which is running and assumed to be error-free. In embodiments of the invention, the documentation is split into logical parts that can be associated to specific use cases and automatically validated by a software that is able to read the documentation, extract the proper information, code/build the corresponding test application, run the test application and check the result.

Embodiments of the invention propose a computer implemented method of software product documentation review that involves, for example, importing a description of a structure of the product documentation for use in determining locations in the product documentation from which to extract code and/or command portions of the product documentation for testing and also providing pre-defined test case stub files for the product documentation, which test case stub files have tags indicative of locations for insertion of extracted portions of the product documentation for testing.

According to embodiments of the invention, the code and/or command portions are extracted from the product documentation at locations based on the documentation structure description by a parser/validator component and inserted into the test case stub files at locations indicated by the tags. The test case stub files are run with the code and/or command portions inserted, and a validating test report for the product documentation is generated if the test case stub files with the code and/or command portions inserted are runnable. On the other hand, an error test report is generated if the test case stub files with the code and/or command portions inserted are not runnable.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for implementing a method of software product documentation review that involves checking if code samples are correct and buildable/runnable by extracting code samples from documentation and placing them into a previously defined test case stub and executing the test cases by an automated test framework.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an example of a table showing the platform dependencies of commands for embodiments of the invention;

FIG. 2 is a schematic diagram that illustrates a high level overview of an example of the architecture for the documentation validation method for embodiments of the invention;

FIG. 3 is a schematic diagram that illustrates an example of components and flow of information between components in the process of document validation for embodiments of the invention; and

FIG. 4 is a flow chart that illustrates an example of the process of automated document testing for embodiments of the invention.

The detailed description explains the preferred embodiments of the invention, together with advantages and features, by way of example with reference to the drawings.

### DETAILED DESCRIPTION OF THE INVENTION

According to the method for embodiments of the invention, the documentation is split into logical sections according to the specific software use cases. In particular every use case maps a documentation part. Each use case has an associated XML schema and/or grammar rules for defined features including a description on how to read/parse documentation (e.g., how to understand that a line represents a command and how to understand that some of the options are optional and others mandatory). Code samples are also marked in the documentation and associated to a specific use case.

The process of automated documentation validation for embodiments of the invention consists of checking various matters for correctness. For example, the automated documentation validation process involves checking that documentation contains all use cases described correctly according to defined grammatical rules and XML schemas.

The process for embodiments of the invention also involves checking if code samples are correct and buildable/runnable. This is done by extracting code samples from documentation and placing them into a previously defined test case stub. Test cases constructed in that way are executed by an automated test framework (i.e. component verification test suite).

Further, the automated documentation validation process for embodiments of the invention involves checking if command line commands as described in the documentation are working correctly and all of the expected options are listed and work as designed. This is done in a similar way as for code samples, the only difference being in the implementation of test case stubs.

In addition, the process for embodiments of the invention involves checking correctness of syntactical/compatibility tables (e.g., tables showing the platform dependencies of commands or the relationships between commands). This is done by parsing the table, building the proper column/row matches and executing the corresponding commands

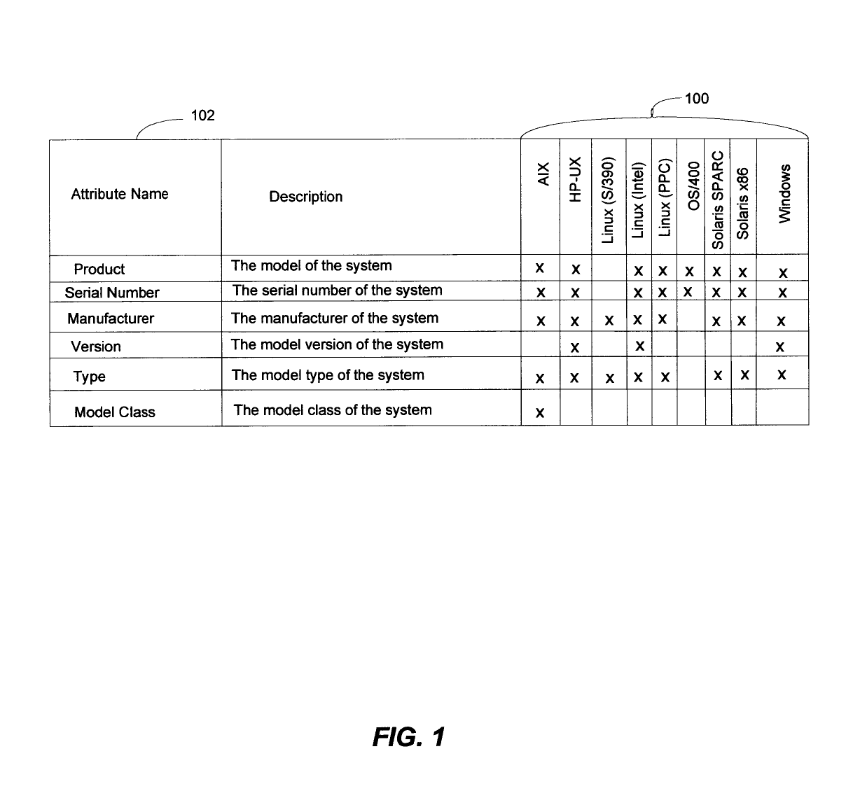

FIG. 1 illustrates an example of a table showing the platform dependencies of commands for embodiments of the invention. Referring to FIG. 1, in the right hand columns 100 appears a list of supported platforms, and in the rows of the ‘Attribute Name’ column 102 on the left is shown the specific data that must appear in the output of a specific command if the intersection between a specific row under the ‘Attribute Name’ and specific platform column is marked by an ‘X’.

For example, if we look at the first row of the ‘Attribute Name’ column 102 we find ‘Product’ and at the first column under the platform ‘AIX’, when running the specific command on AIX, we should expect an attribute called ‘Product’ in the output. If the attribute called ‘Product’ is missing from the output, it is a bug. The opposite is true if running, for example, on Linux (S/390) because the ‘X’ is absent from the intersection of the appropriate row and column.

More specifically, after parsing the table and constructing an XML schema for each platform, it is possible to validate output (eventually converted to XML) for a particular machine. If validation fails, it is possible to detect mismatches between the documentation and the software output. Assuming that the software is stable and sufficiently tested, those mismatches can be considered as documentation problems.

Embodiments of the invention involve, for example, writing test case stub files (i.e., data files or programs that stand in for the original file), which are pieces of code that will execute on the real software, and taking the substance of the extracted documentation and testing it on the real software.

Thus, according to embodiments of the invention, code samples are extracted from the documentation and moved into a test case dump file, which is executed later via a test framework on the real software and produces an output that is correct or incorrect, depending on whether or not the code samples are error-free. If the test case fails, it means that the documentation contained an error for this test case of this extracted piece of code from the documentation.

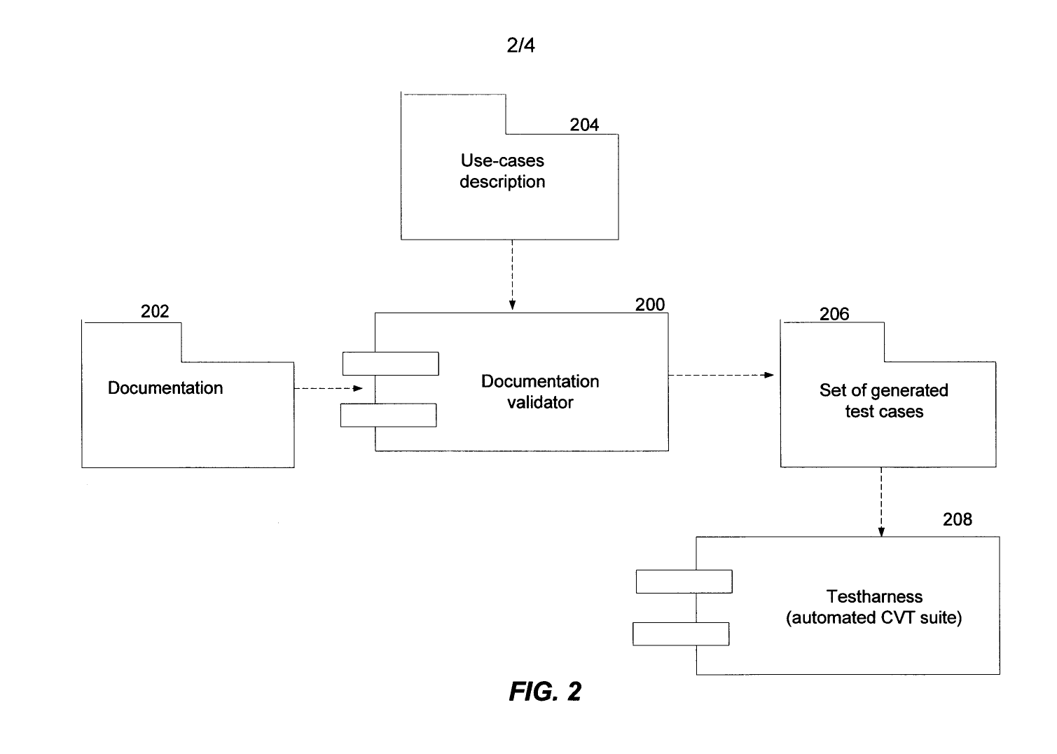

FIG. 2 is a schematic diagram that illustrates a high level overview of an example of the architecture for the documentation validation method for embodiments of the invention. Referring to FIG. 2, a documentation validator 200 receives inputs of documentation 202 and use case descriptions 204 and outputs a set of generated test cases 206 which are in turn input to a test harness 208 (i.e., automated component verification test).

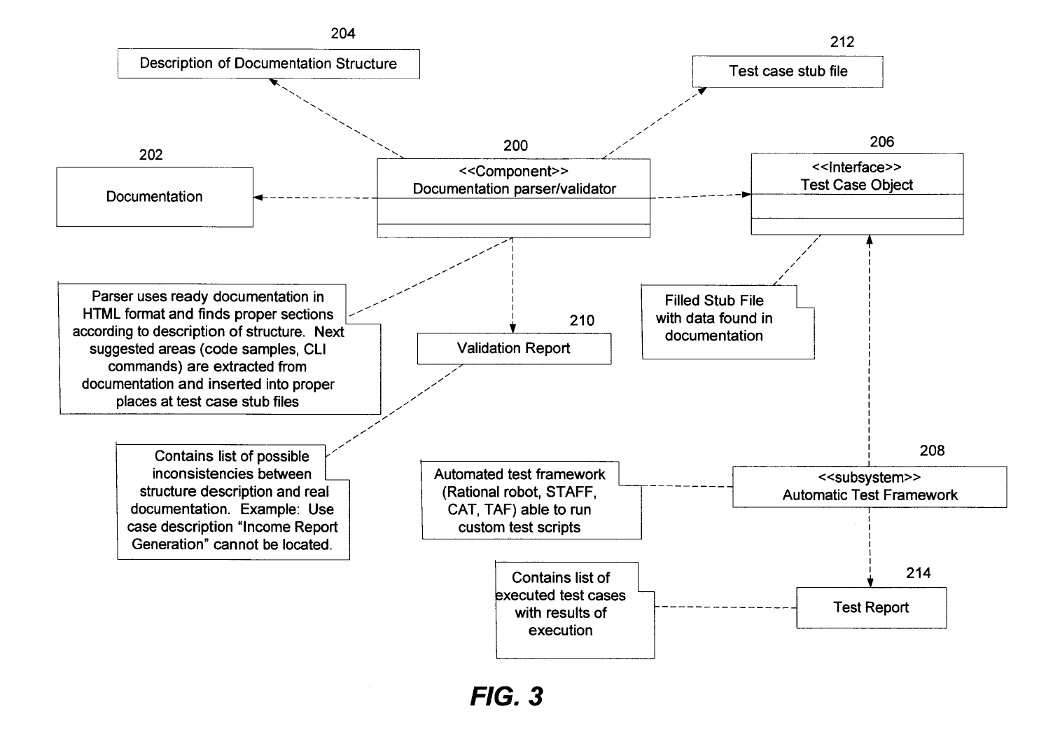

FIG. 3 is a schematic diagram that illustrates an example of components and flow of information between components in the process of document validation for embodiments of the invention. Referring to FIG. 3, the documentation 202 is imported to be tested, and the description of the documentation structure 204 is simply the description of the structure of the documentation, such as an XML file. The documentation parser/validator 200 is a tool for embodiments of the invention that takes the documentation 202 and the description 204 and extracts the pieces of the information that are needed for the test.

The validation report 210 is an outcome of comparing the documentation 202 to the description of the documentation structure 204. Thus, for example, the documentation 202 is totally broken if the Chapters do not match what is expected (e.g., a Chapter is missing), and it is immediately reported in the validation report 210.

The test case stub file 212 is also important to the documentation process. The data extracted from the documentation are simply inserted into the test case stub file 212 as explained in the foregoing example, and thereafter the stub file 212 becomes a test case object 206 that can be executed by the automatic test framework 208. The result of the execution of the test is the test report 214 that indicates that a particular test case has passed or failed.

For an example of the validation process for embodiments of the invention utilizing a “Sample Application”, with reference to FIG. 3, the input for the automated documentation tests is a fragment of product documentation 202 for the “Sample Application” in HTML format, such as command line interface (CLI) commands of the software, that can be extracted. In the following example, a fragment of the CLI of an application is extracted from the documentation 202 and thereafter injected into the test case stub file 212.

### Sample Application

Chapter 1: Command Line Installation
Description of CLI installing method for Sample application

Default Target Path Installation
Following command set allows user to install “Sample application” in default destination directory.
   1. Unpack installation
      Unzip installer.zip
   2. Start command line installation
      Install.sh -i -default
   3. Run the service
      /etc/runSample.sh

Custom Target Path Installation
Following command set allows user to install “Sample application” in custom destination directory.
   4. Unpack installation
      Unzip installer.zip
   5. Start command line installation
      Install.sh -i -path /home/SampleApp
   6. Run the service
      /home/SampleApp/runSample.sh

Chapter 2: Custom Functions

Income Report Generation
Generation of this report can be triggered in integrated environment by using ReportGeneration class.

Example Usage of ReportGeneration Class:

```
ReportGeneration generator = service.getReportGenerator( );
    generator.setStartTime(“2007-01-01”);
    generator.setEndTime(“2007-12-31”);
IncomeReport report = generator.generateIncomeReport( );
```

The documentation structure description file 204 is a file which describes the structural model with which product documentation 202 must comply, and which is used to find the proper places from which to extract information from the real documentation for test purposes. Referring again to FIG. 3, an example of the documentation structure description file 204 for the “Sample Application” is as follows:

```
<?xml version=“1.0” encoding=“UTF-8”?>
<Documentetion xmlns:xsi=“http://www.w3.org/2001/XMLSchema-
instance”>
<Settings>
      <Define name=“CLICommand” font=“CourierNew” size=“12”/>
      <Define name=“CodeSample” font=“CourierNew” size=“10”/>
</Settings>
  <Chapters>
    <Chapter name= “Installation”>
      <UseCaseDescription name=“Command line installation”>
        <CLICommand name= “default target path installation”
testCase=“CLIInstallTest.stub”/>
        <CLICommand name= “custom target path installation”
testCase=“CLIInstallTest.stub”/>
      </UseCaseDescription>
    </Chapter>
    <Chapter name= “Custom functions”>
      <UseCaseDescription name=“Income report generation”>
        <CodeSample name= “Example usage of ReportGeneretor class”
testCase=“IncomeReportTest.stub”/>
      </UseCaseDescription>
    </Chapter>
  </Chapters>
</Documentetion>
```

The test case stub file 212 indicates the location where the code sample that was extracted from the documentation 202 can be inserted, and after insertion at the proper location in the stub file 212, in the example, the “Income Reports” test can be executed on the real software for test purposes. Referring further to FIG. 3, an example of the test case stub files 212 which contain special tags in places where the information extracted from the documentation code or CLI command will be placed for the “Sample Application” is as follows:

```
public class IncomeReportTest {
    public void testIncomeReportGeneration( ){
        //environment preparation
        Service service = SampleApp.getService( );
        @CodeSample
        //simplest test
        assertNull(report);
    }
}
public class CLIInstallTest {
    public void testDefaultPath( ){
        Process proc1 = Runtime.getRuntime( ).exec(@CliCmd1);
        assertEquals(0,proc1.exitValue( ));
        Process proc2 = Runtime.getRuntime( ).exec(@CliCmd2);
        assertEquals(0,proc2.exitValue( ));
        Process proc3 = Runtime.getRuntime( ).exec(@CliCmd3);
        assertEquals(0,proc3.exitValue( ));
    }
}
```

Also referring to FIG. 3, after processing the documentation 202 by the documentation parser/validator 200, possible inconsistencies between the defined structure of the document and real documentation, such as missing descriptions of some use case, can be found.

An example of additional test case stubs 212 also filled with the extracted data is as follows:

```
public class IncomeReportTest {
    public void testIncomeReportGeneration( ){
        //environment preparation
        Service service = SampleApp.getService( );
        //***CODE PASTED BY DOCUMENTATION PARSER***
        ReportGeneration generator = service.getReportGenerator( );
        generator.setStartTime(“2007-01-01”);
        generator.setEndTime(“2007-12-31”);
        IncomeReport report = generator.generateIncomeReport( );
        //*******************************************
        //simplest test
        assertNull(report);
    }
}
```

Referring further to FIG. 3, the foregoing sample test class is received by the automated test framework 208 and executed on the live product. If the foregoing test fails, it means that there is a bug in the extracted part of the documentation. It is noted that passing other functional tests covering the particular area of code may indicate that it is not actually corrupted but that failure of the test may relate to API/CLI interface changes that typically occur as new software releases are introduced.

Automatically testing, according to embodiments of the invention, that examples (e.g. command line commands with parameters or code snippets) in product documentation are correct, and/or that the product documentation complies with a defined product documentation structure, applies primarily to textual documentation samples, targets mainly command-line oriented products, and is most valuable/suitable for example-rich documentation.

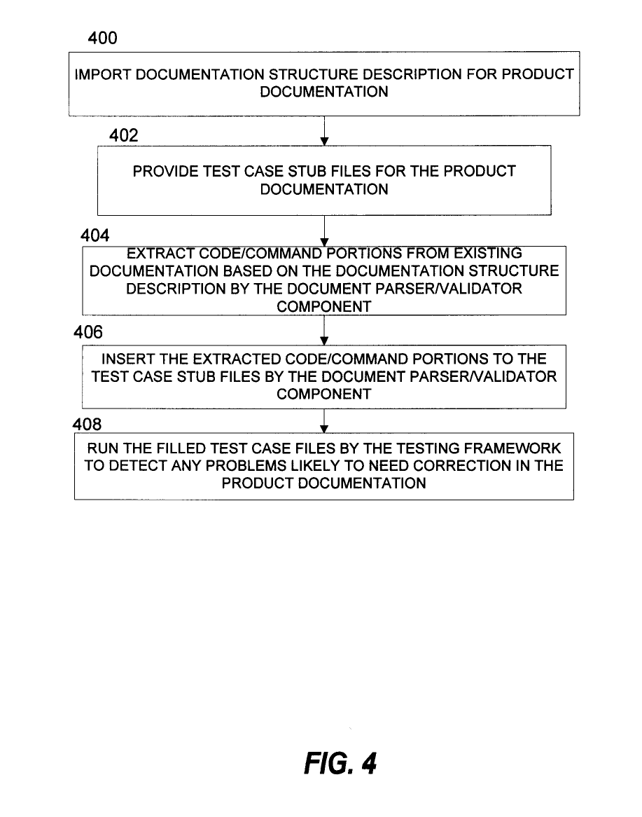

FIG. 4 is a flow chart that illustrates an example of the process of automated document testing for embodiments of the invention. Referring to FIG. 4, at 400, a documentation structure description 204 for product documentation 202 is imported, and at 402, test case stub files 206 for the product documentation 202 are provided. At 404, the document parser/validator component 200 extracts code/command portions from existing documentation based on the documentation structure description 204, and at 406, inserts the extracted code/command portions into the test case stub files 212. At 408, the testing framework (system) 208 runs the filled test case files 206, and problems that arise in testing are indicative of a likely need to correct the examples in the product documentation 202. Also, by comparing the product documentation 202 with the documentation structure description 204, it is possible to check whether the product documentation 202 complies with the defined structure 204.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer implemented method of software product documentation review, comprising:
a. importing a description of a structure of the product documentation for use in determining locations in the product documentation from which to extract at least one of code and command portions of the product documentation for testing;
b. providing pre-defined test case stub files for the product documentation, the test case stub files having tags indicative of locations for insertion of extracted portions of the product documentation for testing;
c. extracting at least one of code and command portions from the product documentation at locations based on the documentation structure description by a parser/validator component;
d. inserting said at least one of the extracted code and command portions into the test case stub files at locations indicated by the tags;
e. running the test case stub files with said at least one of the code and command portions inserted; and
f. generating a validating test report for the product documentation if the test case stub files are runnable with said at least one of the code and command portions inserted or an error test report if the test case stub files are not runnable with said at least one of the code and command portions inserted.
